(19) United States
(12) Patent Application Publication
(10) Pub. No.: US 2023/0138490 A1
(43) Pub. Date: May 4, 2023

(54) Roof Sunshade Device

(71) Applicant: Beth Ann Wexell, Abingdon, IL (US)

(72) Inventor: Beth Ann Wexell, Abingdon, IL (US)

(21) Appl. No.: 17/933,864

(22) Filed: Sep. 21, 2022

Related U.S. Application Data
(60) Provisional application No. 63/273,275, filed on Oct. 29, 2021.

(51) Int. Cl. E06B 9/70

(52) U.S. Cl. CPC E06B 9/70; E06B 2009/6809

(57) ABSTRACT

The present invention relates generally to the field of sunshades. More specifically, the present invention relates to a roof sunshade device comprised of a roller, housing component, at least one shade screen, at least one support frame member, at least one mounting bracket, at least one motor, and at least one remote. The support frame members stretch across the height of the roof and provide a mechanism for the shade screen to move across. A housing component holds a motor-powered roller which can be electronically controlled to deploy and retract the shade screen. Once the shade screen is deployed, the roof is protected from sunlight, and the internal temperature of the home or building is reduced. Accordingly, the present disclosure makes specific reference thereto. Nonetheless, it is to be appreciated that aspects of the present invention are also equally applicable to other like applications, devices and methods of manufacture.

### CROSS-REFERENCE TO RELATED APPLICATION

The present application claims priority to, and the benefit of, U.S. Provisional Application No. 63/273,275, which was filed on Oct. 29, 2021, and is incorporated herein by reference in its entirety.

### FIELD OF THE INVENTION

The present invention relates generally to the field of sunshades. More specifically, the present invention relates to a roof sunshade device comprised of a roller, housing component, at least one shade screen, at least one support frame member, at least one mounting bracket, at least one motor, and at least one remote. The support frame members stretch across the height of a roof and provide a mechanism for the shade screen to move across. A housing component holds a motor-powered roller which can be electronically controlled to deploy and retract the shade screen. Once the shade screen is deployed, the roof is protected from sunlight, and the internal temperature of the home or building is reduced. Accordingly, the present disclosure makes specific reference thereto. Nonetheless, it is to be appreciated that aspects of the present invention are also equally applicable to other like applications, devices and methods of manufacture.

### BACKGROUND

Excessive heat from the sun can be very unpleasant during the spring and summer months. Even if an individual takes shelter in their home, the intense rays from the sun often warm the home to an intolerable temperature. Excess heat may also accumulate in attics and other upstairs rooms creating an environment conducive for mold growth. This effect is compounded in hot and dry climates especially. To mitigate this, an individual must rely on a natural barrier, such as trees, or pay high air conditioning costs. If a person has no natural barrier to the sun and struggles to afford these cooling costs, they are faced with a most undesirable situation.

Therefore, there exists a long-felt need in the art for a roof sunshade device. There also exists a long-felt need in the art for a roof sunshade device that provides shade coverage for an individual's roof to reduce the harmful effects of prolonged sun exposure, which may result in excessive cooling costs. Moreover, there exists a long-felt need in the art for a roof sunshade device that automatically deploys and retracts through a wireless remote. Lastly, there exists a long-felt need in the art for a roof sunshade device that is aesthetically pleasing.

The subject matter disclosed and claimed herein, in one embodiment thereof, comprises a roof sunshade device, further comprised of a roller, housing component, at least one shade screen, at least one support frame member, at least one mounting bracket, at least one motor, and at least one remote. The mounting bracket is attached to the peak of the roof and holds the housing component through at least one fastener. The housing component, in turn, holds a roller. The roller is powered by a motor so that it may automatically deploy and retract the shade screen by using a wireless electronic remote. To support the shade screen, the device features at least one support frame member that is attached to the roof and runs perpendicular to the housing component. The support frame member may be enhanced with angled support frame members to increase the height of the device and in turn, provide more shade.

In this manner, the roof sunshade device of the present invention accomplishes all of the foregoing objectives and provides a mechanism to reduce the amount of sunlight cast on a user's roof. Further, because the device features a motor and a remote that electronically communicates with one another, the device is easily deployed and retracted by the click of a button. Lastly, because the shade screen may be customized with decorative indicia, the device is aesthetically pleasing.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a roof sunshade device. The device is primarily comprised of a housing, at least one shade screen, at least one support frame member, at least one mounting bracket, and at least one motor. The support frame members are preferably fixed to a roof stretching from the bottom edge of the roof to the peak of the roof. A housing component runs across the width of the roof and rests perpendicular to the support frame members. The housing component may be removably attached to at least one mounting bracket, while the mounting bracket(s) may be removably or fixedly attached to the roof. The support frame members may further be comprised of angled support frame members to heighten the device. These structural components are preferably comprised of metal.

The housing component encases a roller which is powered by a motor. The motor may be controlled electronically by a wireless remote. In this manner, the shade screen may automatically be deployed or retracted. To move, the shade screen is fastened to a tongue that easily slides along a groove in the angled support frame members. In this manner, the shade screen may move across the length of the angled support frame member to deploy and retract. Once the shade screen is unwound from the roller and stretched out, it begins to block sunlight creating an area of shade over the roof. In differing embodiments, the shade screen may feature decorative indicia to enhance its appearance.

Accordingly, the roof sunshade device of the present invention is particularly advantageous as it provides an area of shade over the user's roof. Moreover, because the device features a motor and a remote, the shade screen is easily deployable and retractable for use. Lastly, the device is very astatically pleasing and blends in nicely with each individual's home due to the customizable indicia that the device may feature. In this manner, the roof sunshade device provides a novel solution for an existing problem.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to the provided drawings in which similar reference characters refer to similar parts throughout the different views, and in which:

FIG. 1 illustrates a perspective view of one potential embodiment of a roof sunshade device of the present invention in accordance with the disclosed architecture;

FIG. 2 illustrates a perspective view of one potential embodiment of a roof sunshade device of the present invention in accordance with the disclosed architecture;

FIG. 3 illustrates a perspective view of one potential embodiment of a roof sunshade device of the present invention in accordance with the disclosed architecture;

FIG. 4 illustrates a side view of one potential embodiment of a roof sunshade device of the present invention in accordance with the disclosed architecture;

FIG. 5 illustrates a front view of a remote of one potential embodiment of a roof sunshade device of the present invention in accordance with the disclosed architecture; and

FIG. 6 illustrates a graphical view of a mobile application of one potential embodiment of a roof sunshade device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a roof sunshade device. There also exists a long-felt need in the art for a roof sunshade device that provides shade over a user's roof to mitigate the costs necessary to cool a home. Moreover, there exists a long-felt need in the art for a roof sunshade device that can be controlled through a wireless remote. There also exists a long-felt need in the art for a roof sunshade device that automatically deploys and retracts. Lastly, there exists a long-felt need in the art for a roof sunshade device that is visibly appealing and fits in well with a person's home style.

The present invention, in one exemplary embodiment, is comprised of a roller, housing component, at least one shade screen, at least one support frame member, at least one mounting bracket, at least one motor, and at least one remote. The support frame members are fixed to the roof and stretch from the bottom edge of the roof to the roof's peak. The housing component is positioned across the width of the roof and runs perpendicular to the support frame members. At least one mounting bracket is attached to the peak of the roof. The housing component may then be removably or fixedly attached to the mounting bracket through at least one fastener. The support frame members may further be augmented with additional angled support frame members to form a triangle shape. This may increase the height of the shade screen and provide additional shade. These structural components are preferably comprised of a metal material.

A roller is encased within the housing component. The roller is powered by the motor which may be electronically controlled by a wireless remote. In this manner, the shade screen automatically deploys and retracts. The shade screen is fastened to a tongue that slides along a groove in the angled support frame members. In this manner, the shade screen moves across the length of the angled support frame member when unwound and retracted.

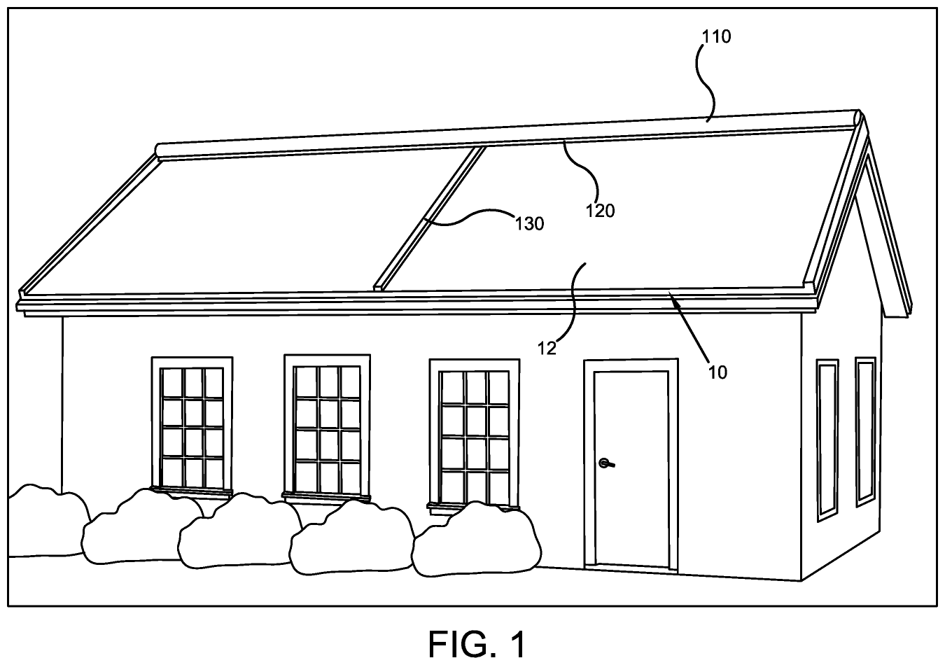

Referring initially to the drawings, FIG. 1 illustrates a perspective view of one potential embodiment of a roof sunshade device 100 of the present invention in accordance with the disclosed architecture. The device 100 is primarily comprised of a housing 110, at least one shade screen 120, at least one support frame member 130, at least one mounting bracket 150, and at least one motor 170. The support frame member 130 is fixedly or removably secured to the top surface 14 of a roof 10 through at least one fastener 160 such as, but not limited to: screw, nail, bolt, magnet, etc. The support frame member 130 is preferably, generally rectangular in shape and is designed to fit across the height of a roof 10 from its peak 12 to its bottom edge (i.e., the edge nearest the ground surface). The support frame member 130 is preferably manufactured from steel or any other metal known in the art. In different embodiments, the support frame member 130 may also be manufactured from a durable polyvinyl chloride plastic or other plastic known in the art such as, but not limited to: acrylic, polycarbonate, polyethylene, thermoplastic, acrylonitrile butadiene styrene, low-density polyethylene, medium density polyethylene, high-density polyethylene, polyethylene terephthalate, polyvinyl chloride, polystyrene, polylactic acid, acetal, nylon, fiberglass, etc.

The housing 110 preferably runs along the entire peak 12 of a roof 10, or however long a user desires to accommodate their shade needs (i.e., needing to shade only a portion of a roof 10). The housing 110 is preferably manufactured from the same materials as the support frame members 130, but may be manufactured from any material known in the art. In different embodiments, the housing 110, support frame members 130, and the shade screen 120 may be ameliorated with a water-resistant coating, anti-corrosive coating, and/or an anti-mildew coating. The support frame member 130 attaches to the housing 110 at the peak 12 of the roof 10. At least one shade screen 120 may be deployed and extended over the support frame member 130, emerging from the housing 110, or retracted across the support frame member 130 and concealed within the housing 110 when not in use. When the device 100 is retracted, the housing 110 offers protection to the shade screen 120 from inclement weather.

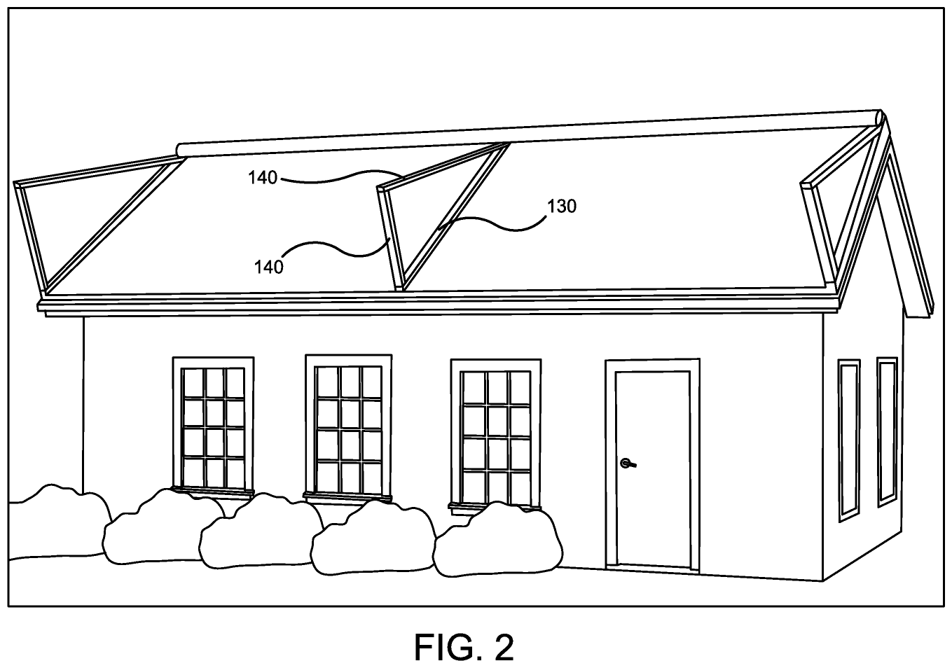

FIG. 2 illustrates a perspective view of one potential embodiment of a roof sunshade device 100 of the present invention in accordance with the disclosed architecture. In one embodiment, at least one support frame member 130 may be attached to at least one angled support frame member 140. Preferably, two angled support members 140 can be fastened together at the desired angle. One end of the first angled support member 140 can be fastened to the end of the support frame member 130 nearest the bottom edge of the roof 10, while the other end of the second angled support frame member 140 can be fastened to the end of the support frame member 130 nearest the peak 12 of the roof 10. In this manner, the angled support frame members 140 and support frame member 130 will be fixed, generally triangular shape.

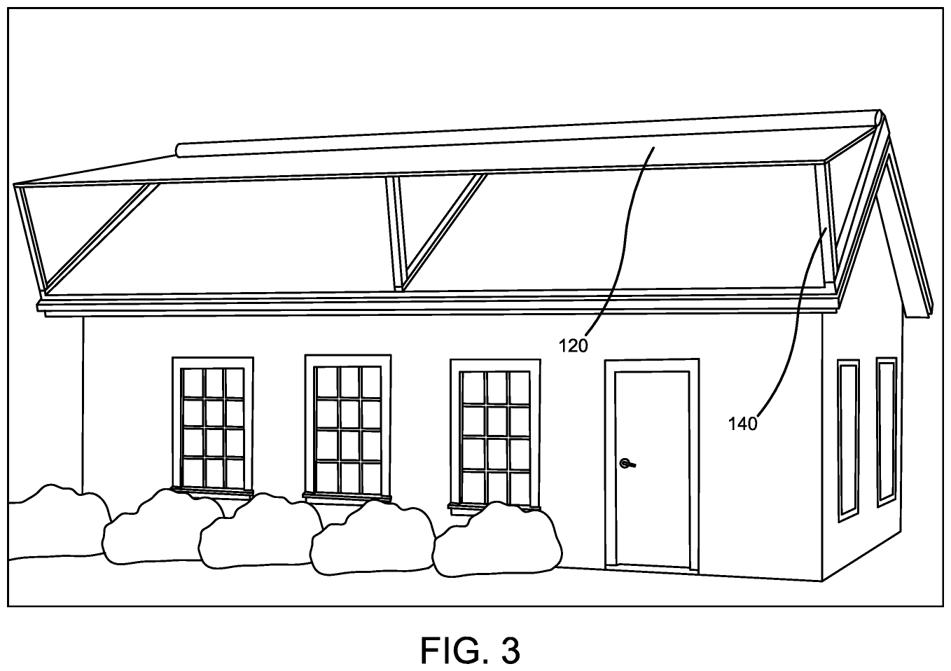

FIG. 3 illustrates a perspective view of one potential embodiment of a roof sunshade device 100 of the present invention in accordance with the disclosed architecture. The shade screen 120 is preferably manufactured in a durable fabric that is ultrasonically seam stitched to ensure the greatest protection from UV rays. Additionally, the shade screen 120 may be enhanced with fade-resistant dye to ensure the shade screen's 120 appearance remains vibrant. In different embodiments, the shade screen 120 may be comprised of any fabric known in the art, such as, but not limited to: vinyl, canvas, cashmere, chenille, chiffon, cotton, damask, jersey, lace, linen, wool, modal, polyester, satin, silk, spandex, suede, tweed, twill, velvet, acrylic, modacrylic, nylon, polypropylene, polyurethane, polyvinyl chloride, polyethylene, vinylidene, benzoate, aramid, rayon, acetate, triacetate, etc.

The shade screen 120 may be deployed from the housing 110 and may move along the angled support frame members 140 to become deployed and block sunlight. The angled support frame members 140 are comprised of at least one groove 142 that run along the length of the angled support frame member 140. In this manner, the shade screen 130 may be securely received and extended across the angled support frame member 140. In differing embodiment, the angled support frame member 140 may be adjustable in height/length to provide a user the ability to adjust the device 100 to the necessary height depending on the angle of the sun.

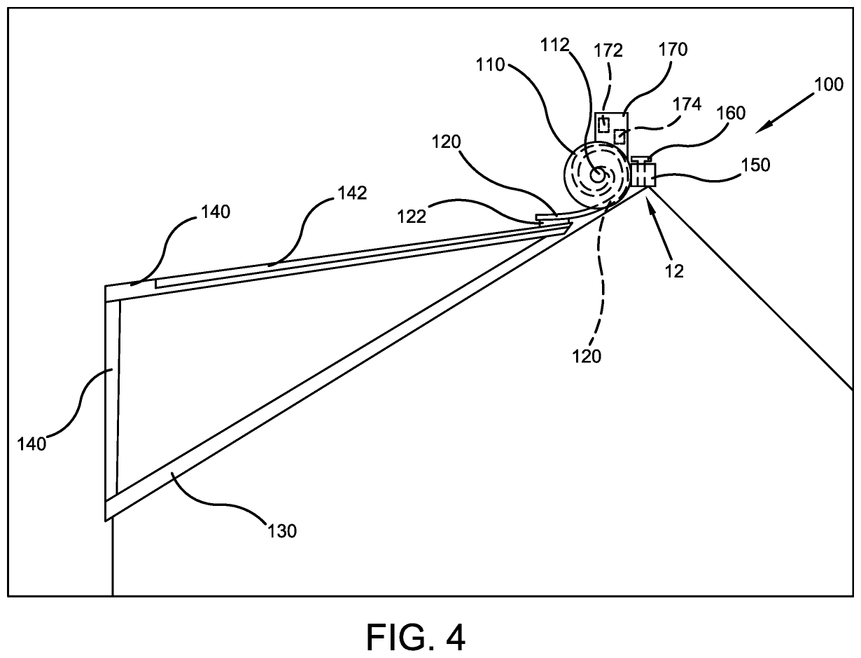

FIG. 4 illustrates a side view of one potential embodiment of a roof sunshade device 100 of the present invention in accordance with the disclosed architecture. At least one housing 110 is attached to the peak 12 of the roof 10 by at least one mounting bracket 150 and encases at least one roller 112. The mounting bracket 150 has at least one fastener 160 that allows the mounting bracket 150 to be fixedly or removably attached to the roof 10. Said fastener 160 may include, but is not limited to: screw, nail, bolt, etc. The roller 112 is generally cylindrical and is powered by a motor 170. The motor 170 may rotate the roller 112 clockwise to deploy the shade screen 120 or counterclockwise to retract the screen 120. The shade screen 120 may be attached to a tongue 122, which moves up and down the angled support frame member 140 via grooves 142. The grooves 142 run across the length of the angled support frame member 140. The motor 170 is further comprised of a transmitter 172 and a processor 174 that allows the motor 170 to be placed in electrical communication with a remote 180.

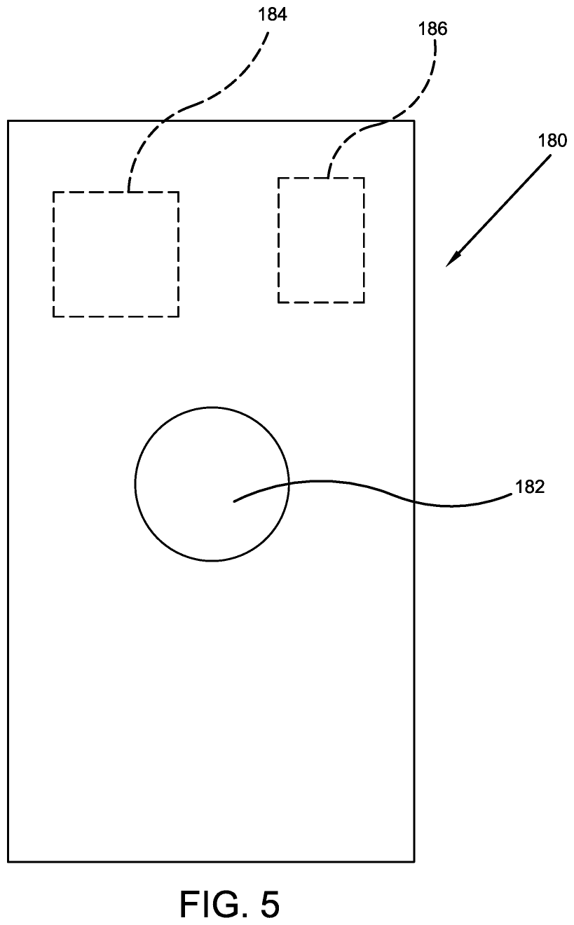

FIG. 5 illustrates a front view of a remote of one potential embodiment of a roof sunshade device 100 of the present invention in accordance with the disclosed architecture. The shade screen 120 may be deployed and retracted through a remote 180 which is in wireless electrical communication with the motor 170. The remote 180 is comprised of a transmitter 184, at least one button 182, and a processor 186. The transmitter 184 of the remote 180 is in wireless electrical communication with the transmitter 172 of the motor 170. The processor 174 on the motor 170 receives and executes commands given by the processor 186 of the remote 180. The wireless electrical communication is preferably accomplished through Bluetooth. In differing embodiments, the wireless electrical communication may be accomplished through any wireless electrical communication type known in the art, such as, but not limited to: WIFI, RFID, radiofrequency, infrared, etc.

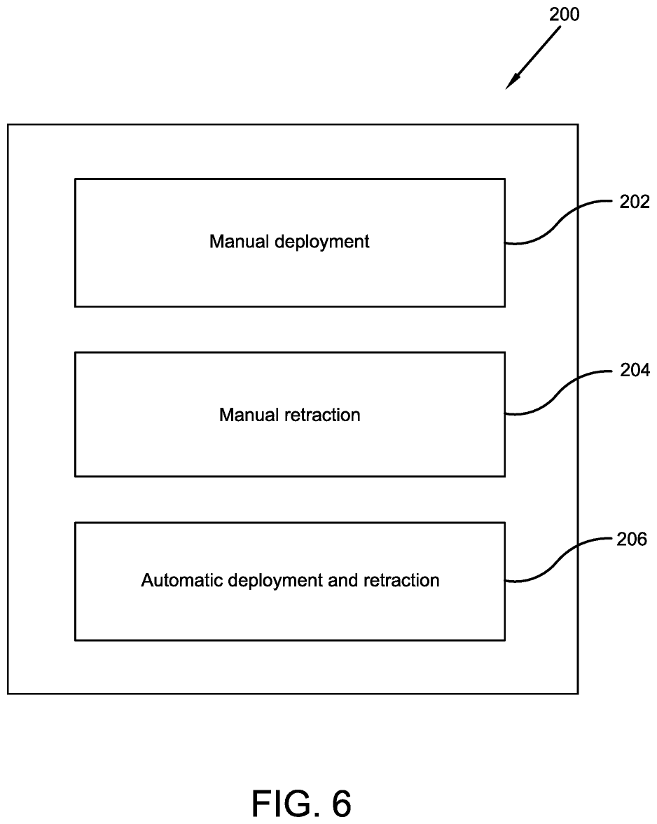

FIG. 6 illustrates a graphical view of a mobile application 200 of one potential embodiment of a roof sunshade device 100 of the present invention in accordance with the disclosed architecture. In differing embodiments, a mobile application 200 may perform the same functions as the remote 180 such as manual deployment 202 and manual retraction 204 of the screen 120. The mobile application 200 is preferably in wireless electrical communication with the motor 170 in the same manner as the remote 180. The mobile application 200 may feature additional functions. By means of example, the mobile application 200 may be comprised of a feature that automatically deploys and retracts 206 the shade screen 120 at certain times of the day or at or above certain temperatures and for specific periods of time. The mobile application 200 can be used on any smart device.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “roof sunshade device” and “device” are interchangeable and refer to the roof sunshade device 100 of the present invention.

Notwithstanding the forgoing, the roof sunshade device 100 of the present invention and its various components can be of any suitable size and configuration as is known in the art without affecting the overall concept of the invention, provided that they accomplish the above-stated objectives. One of ordinary skill in the art will appreciate that the size, configuration and material of the roof sunshade device 100 as shown in the FIGS. are for illustrative purposes only, and that many other sizes and shapes of the roof sunshade device 100 are well within the scope of the present disclosure. Although the dimensions of the roof sunshade device 100 are important design parameters for user convenience, the roof sunshade device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A roof sunshade device comprising:
a housing further comprised of a roller and a motor;
a shade screen attached to the roller;
a support frame member;
a mounting bracket; and
a remote.

2. The roof sunshade device of claim 1, wherein the shade screen can be deployed or retracted along the support frame member.

3. The roof sunshade device of claim 1, wherein the remote is in electrical communication with the motor.

4. A roof sunshade device comprising:
a housing further comprised of a roller and a motor, wherein the motor is further comprised of a transmitter and a processor;
a shade screen attached to the roller;
a support frame member;
a mounting bracket;
a fastener; and
a remote further comprised of a button, a transmitter and a processor.

5. The roof sunshade device of claim 4, wherein each of the housing, the support frame member and the shade screen further comprise at least one of a water-resistant coating, an anti-corrosive coating and an anti-mildew coating.

6. The roof sunshade device of claim 4, wherein the shade screen is ultrasonically seemed stitched.

7. The roof sunshade device of claim 6, wherein the shade screen comprises a fade-resistant dye.

8. The roof sunshade device of claim 4, wherein the transmitter of motor is in wireless electrical communication with the transmitter of the remote.

9. The roof sunshade device of claim 8, wherein the processor of the motor receives and executes commands given by the processor of the remote.

10. A roof sunshade device comprising:
a housing further comprised of a roller and a motor, wherein the motor is further comprised of a transmitter and a processor;
a shade screen attached to the roller;
a support frame member;
an angled support frame member;
a mounting bracket;
a fastener;
a remote further comprised of a button, a transmitter and a processor; and
a mobile application.

11. The roof sunshade device of claim 10, wherein the angled support frame member attaches to the support frame member.

12. The roof sunshade device of claim 10, wherein the mobile application is in electrical communication with the motor.

13. The roof sunshade device of claim 12, wherein the mobile application controls the motor.

14. The roof sunshade device of claim 13, wherein the mobile application allows a user to manually deploy and manually retract the shade screen from the housing.

15. The roof sunshade device of claim 14, wherein the mobile application automatically deploys the shade screen from the housing at certain times of day.

16. The roof sunshade device of claim 15, wherein the mobile application automatically deploys the shade screen at or above a certain temperature.

17. The roof sunshade device of claim 10, wherein the motor rotates the roller clockwise and counterclockwise.

18. The roof sunshade device of claim 10, wherein the mounting bracket attaches to the housing.

19. The roof sunshade device of claim 10, wherein the shade screen is attached to a tongue.

20. The roof sunshade device of claim 19, wherein the tongue is received by a groove of the angle support frame member.
